(19) United States
(12) Patent Application Publication
(10) Pub. No.: US 2026/0054808 A1
(43) Pub. Date: Feb. 26, 2026

(54) OCEANIC ENVIRONMENTAL MONITORING

(71) Applicant: TidalX AI Inc., Mountain View, CA (US)

(72) Inventors: Derek Martin Herbert, Mountain View, CA (US); Julia Black Ling, Menlo Park, CA (US); Terry Allan Smith, Saratoga, CA (US)

(21) Appl. No.: 19/377,568

(22) Filed: Nov. 3, 2025

Related U.S. Application Data
(63) Continuation of application No. PCT/US2024/026020, filed on Apr. 24, 2024.
(60) Provisional application No. 63/499,688, filed on May 2, 2023.

(51) Int. Cl. B63G 8/00; G05B 13/02

(52) U.S. Cl. CPC B63G 8/001; G05B 13/0265; B63G 2008/005

(57) ABSTRACT

Methods, systems, and apparatus, including computer programs encoded on computer storage media, for environmental monitoring. One of the methods includes obtaining sensor data from sensors positioned within an environment; providing the sensor data to one or more machine learning models trained to predict a likelihood of a particular effect on the environment by machinery deployed within the environment; and adjusting, using output from the one or more machine learning models, one or more operations of the machinery in the environment.

### CROSS-REFERENCE TO RELATED APPLICATIONS

This application is a continuation and claims priority of International Patent Application No. PCT/US2024/026020, filed Apr. 24, 2024, which claims priority of U.S. Provisional Patent Application No. 63/499,688, filed on May 2, 2023. The contents of the prior applications are incorporated herein by reference in their entirety.

### FIELD

This specification generally relates to a system, e.g., of sensors and display, for offshore monitoring, such as monitoring of biodiversity and ocean health in an offshore construction or utility area, e.g., of wind farms or drilling rigs.

### BACKGROUND

Offshore operations (e.g., wind farming, oil drilling, among others) pose environmental risks. Although offering numerous benefits, human encroachment into aquatic environments can have deadly outcomes, sometimes destroying entire ecosystems or increasing global greenhouse gas emissions through organic decay. Offshore operations can affect aquatic ecosystems through electromagnetic and acoustic noise, for example, animal migrations or breeding can be disrupted by noisy environments.

### SUMMARY

The techniques described in this document can be used to track aquatic environments to help reduce the environmental effects of offshore operations. Techniques can include obtaining sensors data from multiple different types of sensors, processing that data using one or more machine learning models, and using an output of that processing to help control offshore operations. Techniques can include generating and transmitting one or more signals that cause components operating an offshore operation to change operation. The change in operation can include shutting off for a period of time, reducing noise levels, reducing discharge of waste, or a combination of these, among others. Techniques can include providing information regarding any effects of offshore operations using a graphical user interface. To account for environmental impact of offshore operations, work can be done prior to construction to select sites and predict impacts. Techniques described can improve on traditional methods of visual surveillance or human monitoring of environments by, e.g., predicting environmental hazards or phenomena using statistical or machine learning models, decreasing time between observations and operation adjustments, providing continuous monitoring, providing feedback control to reduce harmful environmental effects, improving comparisons over time by standardizing observations, or a combination of these, among others.

In some implementations, techniques include combining sensor data from multiple sensors—e.g., fixed sensors, autonomous or piloted underwater vehicles, aerial vehicles, satellites, weather stations, or a combination of these. One or more machine learning models can be used to process obtained sensor data. For example, one or more models can be trained to detect species or estimate populations within a sensed environment. Output from the models can be used to adjust operations—e.g., adjusting one or more digital or mechanical actuators to change offshore operations. Techniques can include generating one or more graphical elements that, e.g., represent sensed data or output from one or more trained models that process the sensed data. The graphical elements can be provided to one or more devices, such as computers of operators. In some cases, graphical elements can include instantaneous, or near-instantaneous, time-series geospatial data indicating acoustic noise, electromagnetic noise, water quality, or other environmental indicators.

Advantageous implementations can include one or more of the following features. For example, techniques described can reduce or eliminate effects on environments caused by various technology, e.g., offshore operations, such as wind power harvesting, hydropower harvesting, drilling, or other operations. Because environments are dynamic, the effects on the environments by such operations can vary over time. The described techniques can be configured to account for the dynamic nature of these effects by actively monitoring an environment, such as an aquatic environment, and adjusting operations to help reduce the effects—e.g., adjusting operations based on whether or not a specific type of wildlife is detected within a threshold distance from operations. Techniques described herein can combine sensor data from multiple sensors to help control operations of an offshore system, e.g., to reduce noise levels when a specific organic life is within a threshold distance of the offshore system, and adjust operation again after the specific organic life is more than the threshold distance away from the offshore system. Operations can be controlled using feedback mechanisms to adjust one or more offshore operations, e.g., in response to sensor detections or results from processing a combined set of sensor data.

In general, one innovative aspect of the subject matter described in this specification can be embodied in methods that include the actions of obtaining sensor data from sensors positioned within an environment; providing the sensor data to one or more machine learning models trained to predict a likelihood of a particular effect on the environment by machinery deployed within the environment; and adjusting, using output from the one or more machine learning models, one or more operations of the machinery in the environment. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: The one or more operations of the machinery in the environment comprise one or more operations in a process of an offshore aquatic environment. Feature 2: The one or more operations comprise drilling or wind farming. Feature 3: Actions include generating data using one or more environmental models; and providing the sensor data and the generated data to the machine learning models to generate the output. Feature 4: The sensors comprise one or more of a persistent sensor, satellite, or drone. Feature 5: The drone is a remotely operated submersible vehicle. Feature 6: The drone is an aerial drone. Feature 7: The output indicates one or more of the following: anomaly detections, correlation analysis, animal identification, animal health, biodiversity quantification, species distribution estimation, or behavior analysis. Feature 8: Actions include generating a display interface representing at least a portion of the output; transmitting data representing the display interface to a user device; and adjusting the one or more operations of the machinery using the output and input data received from the display interface of the user device.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for environmental monitoring.

FIG. 2 is a flow diagram illustrating an example of a process for environmental monitoring.

FIG. 3 is an example user interface representing output from an environmental monitoring system.

FIG. 4 is a diagram illustrating an example of a computing system used for environmental monitoring.

FIG. 5 is a diagram showing an example of an environmental monitoring system.

FIG. 6 is a flowchart of an example process for environmental monitoring.

Like reference numbers and designations in the various drawings indicate like elements.

### DETAILED DESCRIPTION

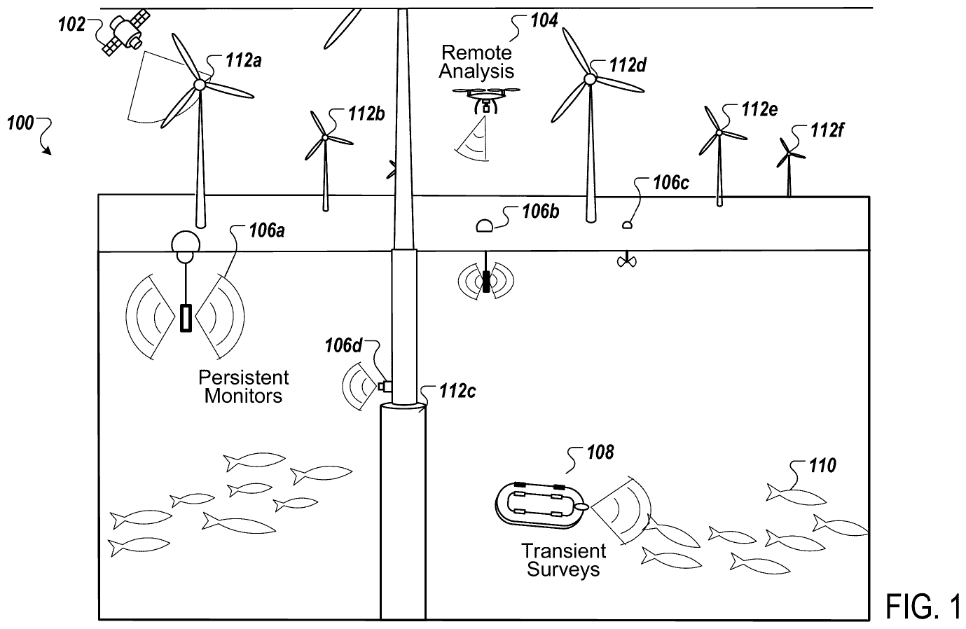

FIG. 1 is a diagram showing an example of a system 100 for environmental monitoring. The system 100 can include a satellite 102, devices for remote analysis (e.g., aerial drone, water based drone, among others), persistent monitors 106a-d (e.g., one or more types of sensors in the water, such as affixed to buoys), submersible devices 108 (e.g., to perform transient surveys of fish 110), among others. FIG. 1 shows an example system 100 for monitoring an environment around a wind farm with wind turbines 112a-f. In some implementations, the system 100 is used for monitoring other environments or other offshore operations. In general, the system 100 can include multiple sensors which can capture sensor data in a variety of modalities—e.g., sonar data, visual data, infrared data, satellite data, water current data, water quality data, temperature data, or a combination of these, among others.

Techniques can include one or more data processing algorithms to process data from one or more devices of the system 100. For example, the system 100 can include a control unit that includes one or more processing elements for performing various processes, e.g., anomaly detection algorithms—such as density-based algorithms—statistical methods based on deviations from the mean, or cluster based algorithms to detect when environmental conditions differ from a baseline. For example, the system 100 can include one or more computers that obtain sensor data from one or more sensors of the system 100, such as the satellite 102, cameras, temperature sensors, or a combination of these, among others. A computer can obtain the sensor data and process the sensor data to determine if there is a significant likelihood that ongoing or planned operations are causing or will cause an effect to an environment, e.g., some sort of environmental harm. A computer can determine if there is a significant likelihood of a given effect by determining if a predicted likelihood satisfies one or more thresholds.

In some implementations, the system 100 uses correlation analysis to determine how various changes in animal behavior, species distribution, or ecosystem health are correlated with factors such as noise level or construction activity. In some implementations, data detected during monitoring is used to inform one or more automatic, semi-automatic, or manual adjustments to offshore operations. For example, the system 100 can determine one or more monitoring values that satisfy one or more thresholds. In response to the monitoring values satisfying the one or more thresholds, the system 100 can instigate an automatic response to effectively reduce an environmental effect correlated with the monitoring values—e.g., turning off or reducing an intensity of one or more operation elements. The monitoring values can represent noise levels underwater, stress of aquatic life, anomalous aquatic life movement, among others.

In some cases, the system 100 can monitor an environment during or after operations—e.g., offshore operations—are performed. In some implementations, by analyzing one or more data correlations between observed environmental effects and operations within the given environment, the system 100 can determine one or more environmental effects from operations. In some cases, the system 100 can halt or adjust one or more sub-operations to help isolate an effect for the one or more sub-operations. Halting or adjusting one or more sub-operations can include adjusting processes—e.g., operating a first set of wind turbines, halting operation of the first set, and then starting operation of a second set to help determine differential effects of the two different operations.

In some cases, information collected using the system 100 can be configured to train one or more machine-learning models to predict effects of operations on an environment. In some implementations, the system 100 can include one or more computing devices executing trained models that are configured to obtain data and generate predictions of environmental effects based on the obtained data. The one or more models can use a form of correlation analysis—e.g., similar activation in layers corresponding to specific environmental effects for different sets of parameters that, nonetheless, produce similar environmental effects. Correlation analysis can include correlating one or more environmental effects with one or more operations conducted by machinery within a given environment. The correlation analysis can include performing one or more operations on obtained environmental monitoring data indicating current statuses of environmental elements, such as wildlife, water quality, air quality, weather, or the like.

In some implementations, the one or more models can be configured to obtain parameters indicative of operations within a particular environment, e.g., offshore operations within an aquatic environment, and predict an effect of the operations on the particular environment based on the parameters. In some cases, the one or more models can be configured to also use sensor data as input indicative of environmental conditions. This can be useful, for example, in situations where the same operation parameters can result in different predicted environmental effects depending on current environmental conditions. The system 100 can obtain output of the models that indicates a likelihood of an effect to an environment. The system 100 can determine if the likelihood satisfies one or more thresholds and, in response, perform an action, e.g., adjust one or more operations or provide feedback to one or more devices.

An example workflow can include (i) a user receiving a notification for an anomalous acoustic level and, in response, (ii) the system 100, or the user manually, modulating ongoing or planned operations. A workflow can include a user tracking an overall impact of their operation on an environment, e.g., by observing changes in fish behavior, species distribution, or ecosystem health over time with specific correlation analysis to time periods of high acoustic impact. One or more values indicating the tracking of the environment can be used by the system 100 to generate results provided for display to a user or to inform automated or semi-automated operations, such as adjustments to one or more operations.

In some implementations, the system 100 includes one or more computers that processes sensor data and generate predictive environmental effects, such as environmental harms. For example, a computer of the one or more computers can perform operations of one or more machine learning models. A model can obtain sensor data as input and provide predictive environmental effects as output. In some cases, a model can use output data from one or more environmental models as input—e.g., from an ocean current, wind, or weather model. Using output of an environmental mode, a model can predict future effects based on predicted environmental changes. For example, an expected drop in temperature from an ocean current model can be provided to one or more models along with current sensor data indicating a family of wildlife currently inhabiting the environment. The models can determine the type of wildlife and a likelihood that the wildlife will migrate from the environment based on the drop in temperature. If the wildlife is prone to specific environmental effects from one or more operations, such as offshore operations, the predicted migration can be used to trigger current or planned operations.

In some implementations, one or more models are trained to detect potential effects based on current operations. For example, a type of machinery, such as a wind turbine, can operate and cause noise within an environment. The noise can be detected in sensor data. The sensor data can be obtained over time along with indications of environmental effects. One or more models can be trained to predict an environmental effect for a give set of input data, such as sensor data. The one or more models can, in some cases, discover trends or unexpected patterns to help reduce environmental effects—e.g., reducing drilling between 2 AM-5 AM when water salinity is below a salinity threshold can reduce a detected environmental effect.

In some cases, models are trained online. For example, models can predict operation adjustments to help reduce one or more environmental effects. Sensor data obtained after the operation adjustments are performed can be used, e.g., by the system 100, to determine if the operation adjustments increased or decreased any environmental effects. The system 100 can adjust one or more values of one or more models based on determining whether the operation adjustments increased or decreased any environmental effects. In some cases, the one or more models includes an environmental effects model. The environmental effects model can be trained to predict environmental effects using data representing current operations and sensor data as input. The system 100 can train the environmental effects model using sensor data obtained over time—e.g., using subsequent data indicating actual effects and comparing the subsequent data to the predicted effects. The trained environmental effects model can be used with one or more additional models to help reduce or eliminate environmental effects. For example, the environmental effects model can be used with an operation adjustment model that predicts operation adjustments—e.g., based on output of the trained environmental effects model. In some cases, the environmental effects model is a first portion of a model for predicting operations—e.g., one or more first layers of the model.

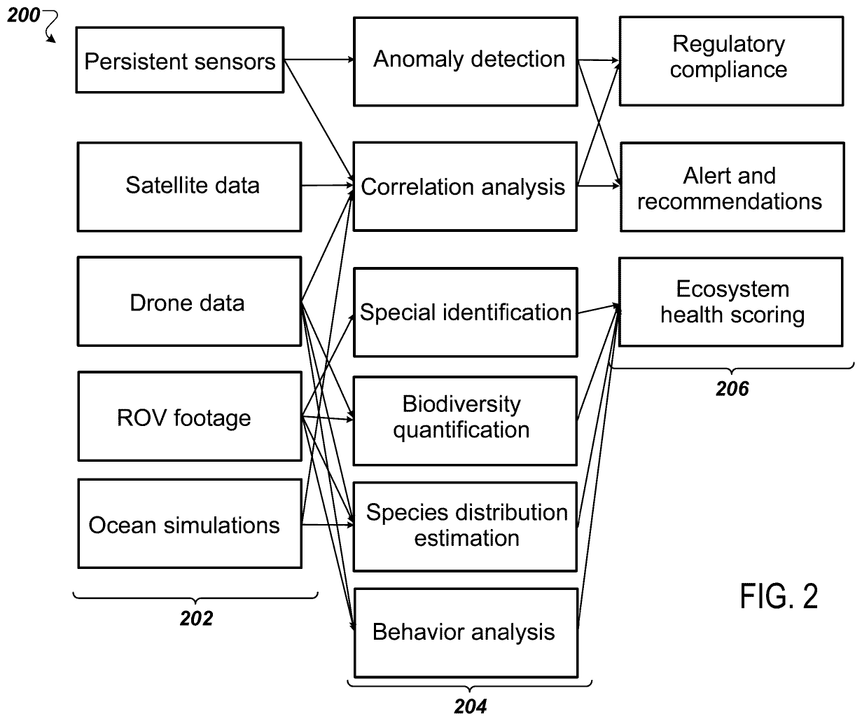

FIG. 2 is a flow diagram illustrating an example of a process 200 for environmental monitoring. One or more elements of the process 200 can be performed by computing devices of the system 100 or computing devices communicably connected to elements of the system 100.

The process 200 includes data 202 provided to one or more processing steps 204. The processing steps 204 can generate one or more of the results 206. In some implementations, a subset of the one or more processing steps 204 are used by the system 100 to generate one or more data values indicating a monitored environment. In some implementations, one or more processing steps not shown in FIG. 2 are performed by the system 100, such as stress level analysis via cortisol levels of aquatic life, among others. In some implementations, stress level analysis is performed using computer-vision-based behavior detection and classification. For example, sensor data can include images of wildlife. A computer vision process can be performed by a computer of the system 100 to identify elements of wildlife and corresponding movement. A model trained to predict a level of stress can be used to process the raw images of wildlife or the extracted movement data of wildlife. Output of the trained model can be used as input data to generate one or more of the results 206, among others.

In some implementations, one or more of the results 206 are used to inform semi-automatic, automatic, or manual adjustments to offshore operations. For example, ecosystem health scoring can be used, e.g., by the system 100, to generate one or more scores. The system 100 can compare the scores to one or more thresholds and based on a comparison to the one or more thresholds, perform one or more automated or semi-automated operations to adjust offshore operations—e.g., change one or more operations of one or more connected mechanical equipment. In some cases, one or more models are trained to perform one or more operations based on one or more computed results. For example, one or more models can obtain on one or more of the results 206. The one or more models can be trained to determine operations based on the results—e.g., adjusting operations if a score of ecosystem health satisfies a threshold. The models can be adjusted overtime based on feedback from adjustments to operations—e.g., operators can provide feedback indicating whether an adjustment or proposed adjustment to operations was correct or incorrect. Feedback can also be determined using subsequent data monitoring—e.g., if subsequent monitoring indicates that the adjustments performed to the operations did not improve one or more of the results 206, the one or more models can be adjusted to generate different predictive operation adjustments.

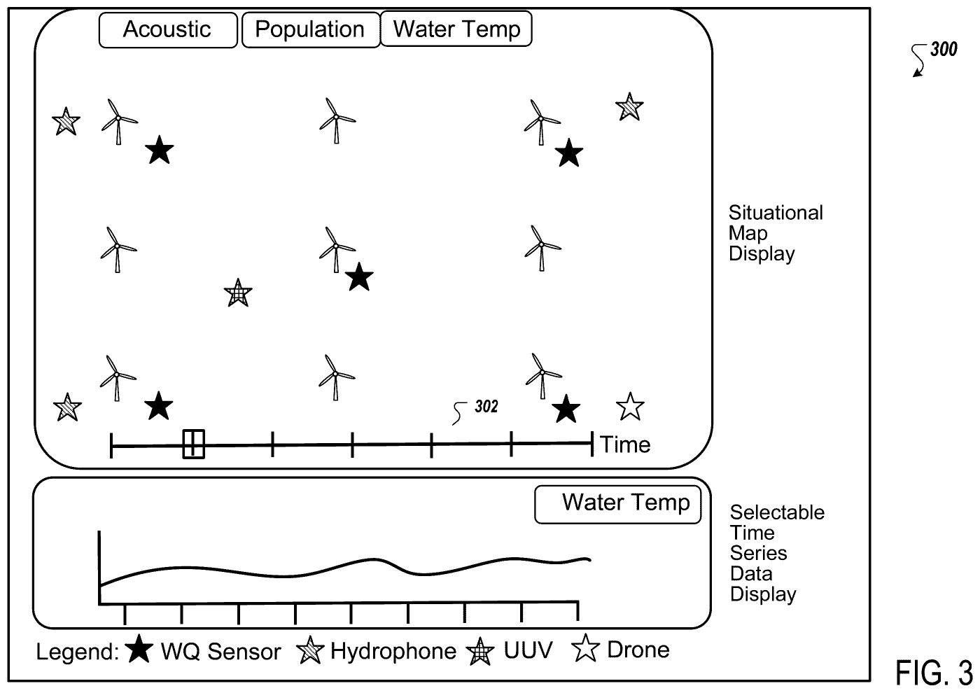

FIG. 3 is an example user interface representing output 300 from an environmental monitoring system, such as the system 100. In some implementations, the system 100 generates the output 300 and transmits data representing the output 300 to a device of a user of the system 100. The user can view the output 300 on a screen of a device and use the output to determine one or more adjustments to a system. In some implementations, the user instructs, through one or more transmitted signals—e.g., through an interface to the system 100—the system 100 to adjust one or more elements of operation.

In some cases, the output 300 includes user interface elements. For example, the output 300 can include a time bar 302. The time bar 302 can be adjusted by a user. The adjustments by a user can cause a computer providing the output 300 to adjust the output 300. The adjustments can show predictive indications of an environment—e.g., predictive hazards or harms from operations based on sensor data or environmental models.

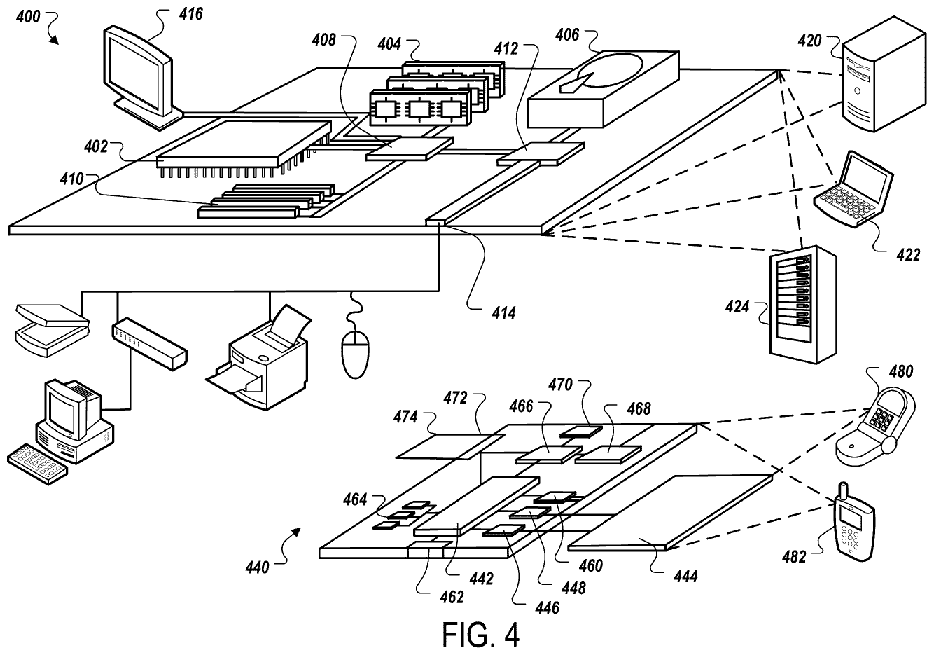

FIG. 4 is a diagram illustrating an example of a computing system used for environmental monitoring. The computing system includes computing device 400 and a mobile computing device 450 that can be used to implement the techniques described herein. For example, one or more components of the system 100 could be an example of the computing device 400 or the mobile computing device 450, such as a computer system implementing one or more computing elements of the system 100, e.g., to perform one or more of the processing steps 204, obtaining data from sensors of the system 100, providing results 206, or adjusting one or more elements of an offshore operation—e.g., a drilling speed, an operation of one or more wind turbines, a schedule of on/off for one or more elements affecting an environment, among others.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

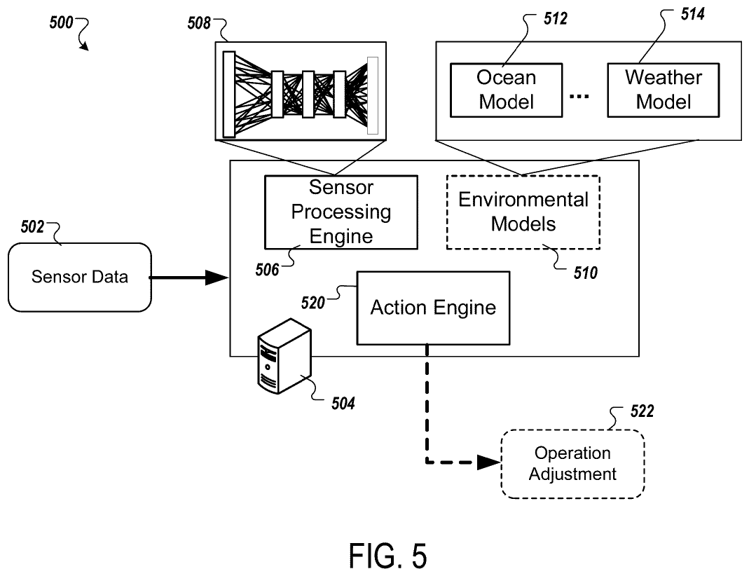

FIG. 5 is a diagram showing an example of an environmental monitoring system 500. The system 500 includes a computer 504. The computer 504 can include one or more processors configured to perform operations described in reference to FIG. 5 and the environmental monitoring described herein. The computer 504 can be communicably coupled to one or more elements of machinery—e.g., machinery performing one or more operations within a monitored environment.

The computer 504 obtains the sensor data 502. The sensor data 502 can be obtained from one or more different types of sensors—e.g., one or more sensors described herein, such as those depicted and described in reference to FIG. 1. The sensors can communicate with one or more elements of the computer 504—e.g., via a network communication infrastructure. In some cases, the computer 504 includes one or more cloud compute instances—e.g., one or more instances that are instantiated to account for less or more sensor data obtained from sensors.

The computer 504 can perform operations of one or more engines-such as the sensor processing engine 506 and the action engine 520. In some cases, the computer 504 performs operations of one or more environmental models 510. The sensor processing engine 506 of the computer 504 can include one or more machine learning models. The sensor processing engine 506 can process data of the obtained sensor data 502. In some cases, the sensor processing engine 506 can correlate one or more items of the sensor data 502 that indicate an environment to one or more operations that are being, or were being, performed in the environment. For example, the sensor data 502 can indicate a type of wildlife is not reproducing at a typical rate—e.g., a rate of reproduction previously obtained via data processed by the system 500. The sensor data 502, or other data obtained from another system by the system 500, can indicate one or more operations that were, or are, being performed during a time period that at least partially overlaps with a period preceding the identified environmental effect. The time period can depend on a time period of effect where some effects take longer to be detected than others. In general, the sensor processing engine 506 can process the sensor data 502 to determine if one or more environmental effects satisfy one or more effect thresholds. By using historically obtained sensor data and historically obtained operations data, the sensor processing engine 506 can determine if one or more operations are causing the one or more effects.

In some cases, the sensor data 502 is used to determine one or more operations. For example, the computer 504 might not have direct access to operations data. The sensor data 502 can instead include audio data, ground movement data, or the like. The sensor processing engine 506 can use the sensor data 502 to determine one or more operations being performed in an environment and to correlate the one or more operations with one or more monitored environmental effects.

In some cases, the sensor processing engine 506 can predict environmental effects. For example, the sensor processing engine 506 can include one or more machine learning models that are trained using obtained monitoring data. After detection of one or more environmental effects, the sensor processing engine 506 can predict if one or more operations being performed by machinery in an environment is likely to cause one or more environmental effects. In some cases, an initial trained version of a model to predict environmental effects using sensor data can predict and store predictions for later training—e.g., after determination using ground truth data or human operator confirmation. In some cases, an initial version sends control signals to operations. The system 500 can continue to monitor after signals are sent to control operation to determine if the control signal was successfully in mitigating or preventing one or more predicted environmental effects.

In some cases, the sensor processing engine 506 includes a model with one or more fully connected layers—e.g., shown graphically in item 508. A fully connected model is shown for illustration purposes. In some cases, other types of models are used. Training methods can include backpropagation algorithms, gradient descent algorithms, or the like.

In some cases, the computer 504 uses one or more environmental models 510. For example, the environmental models 510 can help to predict one or more environmental effects. Environmental models can include, e.g., an ocean model 512, a weather model 514, or a combination of these among other models designed to predict natural environments and their natural time dependency. In some cases, output of environmental models can be used to help improve predictions or detections of environmental effects—e.g., by the sensor processing engine 506. The output of the environmental models 510 can be used as input for one or more process or machine learning models of the sensor processing engine 506. The environmental models 510 can include one or more machine learning models that are separately trained using sensor data, such as the sensor data 502, to predict specific environmental occurrences.

For example, an ocean model 512 can be used to predict ocean environmental changes. The ocean model 512 can help improve detection or prediction of environmental effects, e.g., on wildlife within an area. In particular, if wildlife patterns change with changes of the ocean—e.g., warm water movement, algae blooms, or other natural phenomenon that can be predicted by the ocean model 512—output of the ocean model 512 can help predict or detect environmental effects. Output can indicate specific conditions of the ocean within an environment where operations are performed by machinery. In general, output of environmental models can output predictions of conditions of an environment at some future point in time.

The action engine 520 performs an action using the sensor processing engine 506 output. For example, the sensor processing engine 506 can detect an environmental effect on wildlife within a region of an environment where machinery is being operated. The sensor processing engine 506 can predict an operation adjustment to mitigate or prevent the effect—e.g., temporarily stop machinery, reduce an intensity, start up one or more other machinery within a different region, or a combination of these, among others.

In some cases, the action engine 520 can generate and transmit the operation adjustment 522. The operation adjustment 522 can include signals configured to cause machinery to adjust operations. The action engine 520 can be communicably connected to one or more devices of machinery. In some cases, the action engine 520 includes an encryption module to encrypt messages to adjust operation to help ensure the messages can not be read by third parties who could then potentially remotely control operations using similar protocols. For example, the action engine 520 can perform an encrypted handshake with one or more communicative components of machinery before the machinery accepts control instructions from the action engine 520.

In some cases, the action engine 520 performs an action of displaying information to one or more users. For example, the action engine 520 can generate and provide a graphical user interface that represents one or more elements of information determined by the computer 504. For example, the action engine 520 can generate and provide the output 300 from FIG. 3. In some cases, the computer 504 can provide an interface for input by a user to select from among one or more operations proposed by the computer 504 for mitigating or preventing an environmental effect—e.g., an N number of most likely preventative of mitigative operation adjustments based on processing by the sensor processing engine 506. In response to receiving a user selection, the action engine 520 can then perform the action—e.g., by generating and transmitting a signal to one or more elements of machinery.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

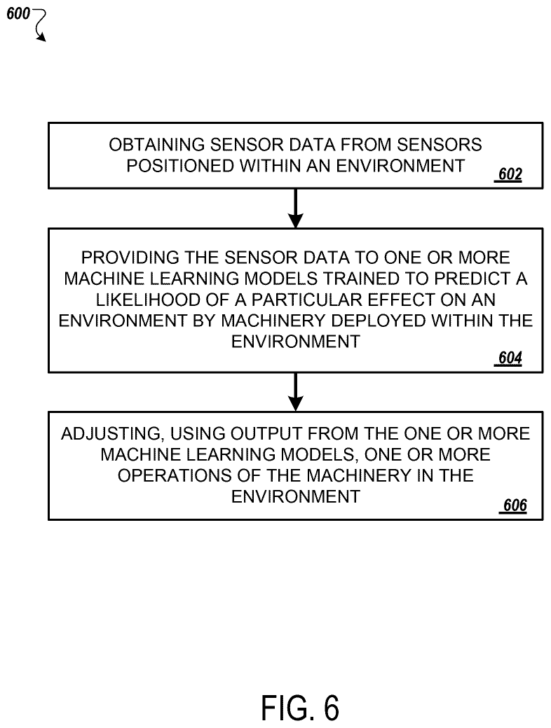

FIG. 6 is a flowchart of an example process 600 for environmental monitoring. For convenience, the process 600 will be described as being performed by a system of one or more computers, located in one or more locations, and programmed appropriately in accordance with this specification. For example, a monitoring system, e.g., the system 500 of FIG. 5, appropriately programmed, can perform the process 600.

The process 600 includes obtaining sensor data from sensors positioned within an environment (602). For example, the computer 504 can obtain the sensor data 502. The sensor data 502 can be generated by one or more sensors—e.g., sensors shown and described in reference to FIG. 1.

The process 600 includes providing the sensor data to one or more machine learning models trained to predict a likelihood of a particular effect on an environment by machinery deployed within the environment (604). For example, the computer 504 can provide the sensor data 502 to the sensor processing engine 506. The sensor processing engine 506 can include one or more models. The models can be trained using one or more subsequently obtained items of processed sensor data as ground truth data—e.g., to confirm a predicted current or future environmental effect. For example, the sensor processing engine 506 can predict biomass to shrink by 5%. Subsequent data can be processed to determine if biomass has shrunk by 5% within a given region. Based on the subsequent determination, the computer 504, or another system, can adjust one or more values of a model to help improve predictions.

The process 600 includes adjusting, using output from the one or more machine learning models, one or more operations of the machinery in the environment (606). For example, the computer 504 can generate and transmit the operation adjustment 522 to one or more elements of machinery to cause the one or more elements of machinery to change operation—e.g., turn off, change operation state, or a combination of these, among others.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method comprising:
obtaining sensor data from sensors positioned within an environment;
providing the sensor data to one or more machine learning models trained to predict a likelihood of a particular effect on the environment by machinery deployed within the environment; and
adjusting, using output from the one or more machine learning models, one or more operations of the machinery in the environment.

2. The method of claim 1, wherein the one or more operations of the machinery in the environment comprise one or more operations in a process of an offshore aquatic environment.

3. The method of claim 2, wherein the one or more operations comprise drilling or wind farming.

4. The method of claim 1, comprising:
generating data using one or more environmental models; and
providing the sensor data and the generated data to the machine learning models to generate the output.

5. The method of claim 1, wherein the sensors comprise one or more of a persistent sensor, satellite, or drone.

6. The method of claim 5, wherein the drone is a remotely operated submersible vehicle.

7. The method of claim 5, wherein the drone is an aerial drone.

8. The method of claim 1, wherein the output indicates one or more of the following: anomaly detections, correlation analysis, animal identification, animal health, biodiversity quantification, species distribution estimation, or behavior analysis.

9. The method of claim 1, comprising:
generating a display interface representing at least a portion of the output;
transmitting data representing the display interface to a user device; and
adjusting the one or more operations of the machinery using the output and input data received from the display interface of the user device.

10. One or more computer-readable storage media encoded with instructions that, when executed by one or more computers, cause the one or more computers to perform operations comprising:
obtaining sensor data from sensors positioned within an environment;
providing the sensor data to one or more machine learning models trained to predict a likelihood of a particular effect on the environment by machinery deployed within the environment; and
adjusting, using output from the one or more machine learning models, one or more operations of the machinery in the environment.

11. The media of claim 10, wherein the one or more operations of the machinery in the environment comprise one or more operations in a process of an offshore aquatic environment.

12. The media of claim 11, wherein the one or more operations comprise drilling or wind farming.

13. The media of claim 10, wherein the operations performed by the one or more computers comprise:
generating data using one or more environmental models; and
providing the sensor data and the generated data to the machine learning models to generate the output.

14. The media of claim 10, wherein the sensors comprise one or more of a persistent sensor, satellite, or drone.

15. The media of claim 14, wherein the drone is a remotely operated submersible vehicle.

16. The media of claim 14, wherein the drone is an aerial drone.

17. The media of claim 10, wherein the output indicates one or more of the following: anomaly detections, correlation analysis, animal identification, animal health, biodiversity quantification, species distribution estimation, or behavior analysis.

18. The media of claim 10, wherein the operations performed by the one or more computers comprise:
generating a display interface representing at least a portion of the output;
transmitting data representing the display interface to a user device; and
adjusting the one or more operations of the machinery using the output and input data received from the display interface of the user device.

19. A system comprising:
one or more computers and one or more storage devices on which are stored instructions that are operable, when executed by the one or more computers, to cause the one or more computers to perform operations comprising:
obtaining sensor data from sensors positioned within an environment;
providing the sensor data to one or more machine learning models trained to predict a likelihood of a particular effect on the environment by machinery deployed within the environment; and
adjusting, using output from the one or more machine learning models, one or more operations of the machinery in the environment.

20. The system of claim 19, wherein the one or more operations of the machinery in the environment comprise one or more operations in a process of an offshore aquatic environment.
